(19) United States
(12) Patent Application Publication
(10) Pub. No.: US 2023/0038937 A1
(43) Pub. Date: Feb. 9, 2023

(54) HANDSFREE INFORMATION SYSTEM AND METHOD

(71) Applicant: RAIN TECHNOLOGY, INC., HERRIMAN, UT (US)

(72) Inventors: Nithya THADANI, New York, NY (US); Nick Godfrey, Old Greenwich, CT (US); Brian Edelman, Mamaroneck, NY (US); Eric Turkington, Everett, WA (US); Will Hall, Mooresville, NC (US); Kimberly Conti, Glastonbury, CT (US); Lauren Madsen, American Fork, UT (US); Kristen Wong, Clifton, NJ (US); Nicholas Rovisa, Jersey City, NJ (US); Ryan Hollander, Longwood, FL (US)

(21) Appl. No.: 17/880,477

(22) Filed: Aug. 3, 2022

Related U.S. Application Data
(60) Provisional application No. 63/230,550, filed on Aug. 6, 2021.

(51) Int. Cl. G10L 15/22; G10L 15/18

(52) U.S. Cl. CPC G10L 15/22; G10L 15/18; G10L 2015/223

(57) ABSTRACT

A method, computer program product, and computing system for monitoring a work environment in which a technician is working on a mechanical asset; detecting the issuance of a textless-input concerning the mechanical asset; processing the textless-input to define a response; and effectuating the response.

### RELATED APPLICATION(S)

This application claims the benefit of U.S. Provisional Application No. 63/230,550, filed on 6 Aug. 2021, the entire contents of which are incorporated herein by reference.

### TECHNICAL FIELD

This disclosure relates to information systems and, more particularly, to hands free information systems for use by deskless workers.

### BACKGROUND

The automotive industry is one of the largest in the US in terms of size and employees. It's also rapidly changing due to technology advancements in vehicles, supply chain shifts, and evolving transportation needs.

While many aspects of the industry march on, others lag behind. Independent repair shops account for a significant number of institutions in the US. These garages are typically local, independently owned, and have few solutions which have helped them innovate since the mid-century.

Vehicle repair complexity has changed dramatically due to onboard computers, driver assist, different manufacturing methods, and other computerized components in the last few decades. A simple repair is often comprised of technical components as well as mechanical. In some cases, all aspects of a repair are technical rather than individualized mechanical components as they once were (e.g., parking assist).

Original equipment manufacturers (OEMs), seek to differentiate their vehicles through improved technology, and continue to hold complicated repair information under close proprietary watch. This becomes challenging for independent repair shops who are expected to service a variety of vehicles - all with evermore complicated components. Information is often out of date, missing, inaccurate, or too generic. At the same time, mechanics performing maintenance and repairs are offered limited upskilling to resolve more complicated problems and OEM manuals haven't evolved in a customer-centric way. Service manuals are hundreds of pages long, non-standardized, difficult to read, and require many cross-referenced pages.

### SUMMARY OF DISCLOSURE

### Textless-Input for a Mechanical Asset

In one implementation, a computer-implemented method is executed on a computing device and includes: monitoring a work environment in which a technician is working on a mechanical asset; detecting the issuance of a textless-input concerning the mechanical asset; processing the textless-input to define a response; and effectuating the response.

One or more of the following features may be included. Monitoring a work environment in which a technician is working on a mechanical asset may include one or more of: audibly monitoring the work environment in which the technician is working on the mechanical asset; visually monitoring the work environment in which the technician is working on the mechanical asset; and monitoring the work environment in which the technician is working on the mechanical asset via a virtual assistant. The mechanical asset may include one or more of: a transportation mechanical asset; a heavy equipment mechanical asset; an agricultural mechanical asset; a manufacturing mechanical asset; a building mechanical asset; a mining mechanical asset; and a drilling mechanical. Detecting the issuance of a textless-input concerning the mechanical asset may include one or more of: detecting the issuance of a verbal input concerning the mechanical asset; detecting the issuance of a vision-based input concerning the mechanical asset; detecting the issuance of a data-based input concerning the mechanical asset; and detecting the issuance of an audio-based input concerning the mechanical asset. The textless-input may include one or more of: a verbal input, a vision-based input, a data-based input, and an audio-based input. Processing the textless-input to define a response may include: processing at least a portion of the textless-input using natural language processing to define the response. Processing the textless-input to define a response may include one or more of: processing at least a portion of the textless-input to identify one or more input-indicative trigger words; processing at least a portion of the textless-input to identify one or more input-indicative conversational structures; and processing at least a portion of the textless-input to identify one or more input-indicative vocal tones / inflections. Processing the textless-input to define a response may include: processing at least a portion of the textless-input on a cloud-based computing resource to define the response. Processing the textless-input to define a response may include one or more of: obtaining information from one or more remote datasources; and basing the response, at least in part, upon at least a portion of this information. Effectuating the response includes one or more of: rendering an image; rendering a video; rendering audio; rendering a printout; augmented reality; and configuring a tool.

In another implementation, a computer program product resides on a computer readable medium and has a plurality of instructions stored on it. When executed by a processor, the instructions cause the processor to perform operations including monitoring a work environment in which a technician is working on a mechanical asset; detecting the issuance of a textless-input concerning the mechanical asset; processing the textless-input to define a response; and effectuating the response.

One or more of the following features may be included. Monitoring a work environment in which a technician is working on a mechanical asset may include one or more of: audibly monitoring the work environment in which the technician is working on the mechanical asset; visually monitoring the work environment in which the technician is working on the mechanical asset; and monitoring the work environment in which the technician is working on the mechanical asset via a virtual assistant. The mechanical asset may include one or more of: a transportation mechanical asset; a heavy equipment mechanical asset; an agricultural mechanical asset; a manufacturing mechanical asset; a building mechanical asset; a mining mechanical asset; and a drilling mechanical. Detecting the issuance of a textless-input concerning the mechanical asset may include one or more of: detecting the issuance of a verbal input concerning the mechanical asset; detecting the issuance of a vision-based input concerning the mechanical asset; detecting the issuance of a data-based input concerning the mechanical asset; and detecting the issuance of an audio-based input concerning the mechanical asset. The textless-input may include one or more of: a verbal input, a vision-based input, a data-based input, and an audio-based input. Processing the textless-input to define a response may include: processing at least a portion of the textless-input using natural language processing to define the response. Processing the textless-input to define a response may include one or more of: processing at least a portion of the textless-input to identify one or more input-indicative trigger words; processing at least a portion of the textless-input to identify one or more input-indicative conversational structures; and processing at least a portion of the textless-input to identify one or more input-indicative vocal tones / inflections. Processing the textless-input to define a response may include: processing at least a portion of the textless-input on a cloud-based computing resource to define the response. Processing the textless-input to define a response may include one or more of: obtaining information from one or more remote datasources; and basing the response, at least in part, upon at least a portion of this information. Effectuating the response includes one or more of: rendering an image; rendering a video; rendering audio; rendering a printout; augmented reality; and configuring a tool.

In another implementation, a computing system includes a processor and a memory system configured to perform operations including monitoring a work environment in which a technician is working on a mechanical asset; detecting the issuance of a textless-input concerning the mechanical asset; processing the textless-input to define a response; and effectuating the response.

One or more of the following features may be included. Monitoring a work environment in which a technician is working on a mechanical asset may include one or more of: audibly monitoring the work environment in which the technician is working on the mechanical asset; visually monitoring the work environment in which the technician is working on the mechanical asset; and monitoring the work environment in which the technician is working on the mechanical asset via a virtual assistant. The mechanical asset may include one or more of: a transportation mechanical asset; a heavy equipment mechanical asset; an agricultural mechanical asset; a manufacturing mechanical asset; a building mechanical asset; a mining mechanical asset; and a drilling mechanical. Detecting the issuance of a textless-input concerning the mechanical asset may include one or more of: detecting the issuance of a verbal input concerning the mechanical asset; detecting the issuance of a vision-based input concerning the mechanical asset; detecting the issuance of a data-based input concerning the mechanical asset; and detecting the issuance of an audio-based input concerning the mechanical asset. The textless-input may include one or more of: a verbal input, a vision-based input, a data-based input, and an audio-based input. Processing the textless-input to define a response may include: processing at least a portion of the textless-input using natural language processing to define the response. Processing the textless-input to define a response may include one or more of: processing at least a portion of the textless-input to identify one or more input-indicative trigger words; processing at least a portion of the textless-input to identify one or more input-indicative conversational structures; and processing at least a portion of the textless-input to identify one or more input-indicative vocal tones / inflections. Processing the textless-input to define a response may include: processing at least a portion of the textless-input on a cloud-based computing resource to define the response. Processing the textless-input to define a response may include one or more of: obtaining information from one or more remote datasources; and basing the response, at least in part, upon at least a portion of this information. Effectuating the response includes one or more of: rendering an image; rendering a video; rendering audio; rendering a printout; augmented reality; and configuring a tool.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an information process according to an embodiment of the present disclosure;

FIG. 2 is a diagrammatic view of a working environment (including a vehicle service bay) according to an embodiment of the present disclosure;

FIG. 3 is a flowchart of the information process of FIG. 1 according to an embodiment of the present disclosure; and

FIG. 4 is a flowchart of the information process of FIG. 1 according to another embodiment of the present disclosure.

Like reference symbols in the various drawings indicate like elements.

### DETAILED DESCRIPTION OF THE PREFERRED EMBODIMENTS

System Overview

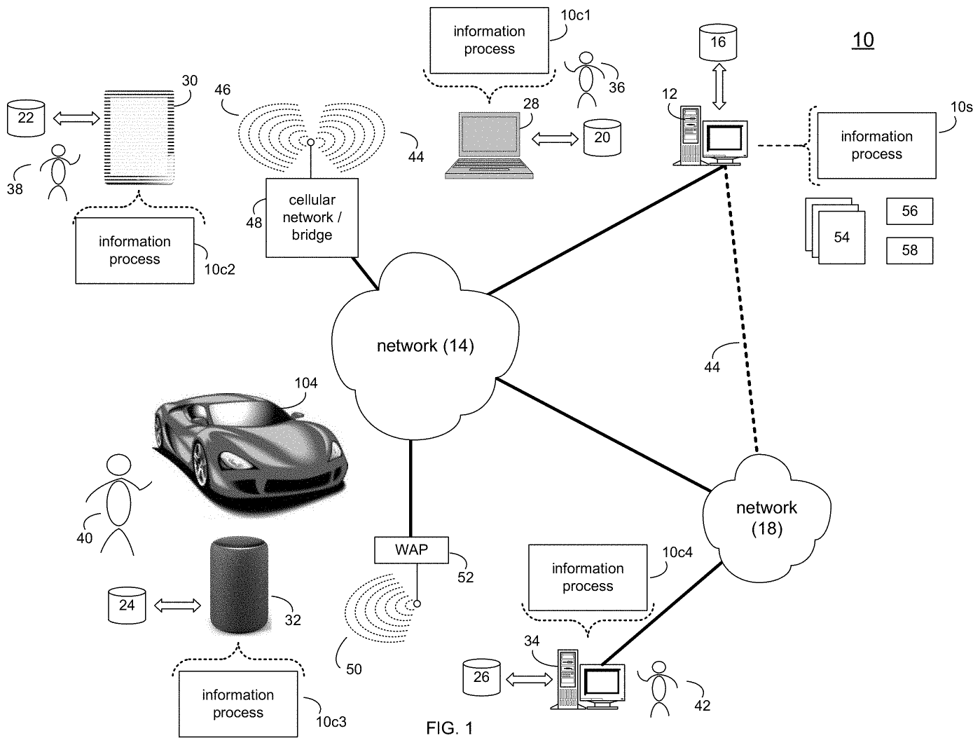

Referring to FIG. 1, there is shown information process 10. Information process 10 may be implemented as a server-side process, a client-side process, or a hybrid server-side/client-side process. For example, information process 10 may be implemented as a purely server-side process via information process 10s . Alternatively, information process 10 may be implemented as a purely client-side process via one or more of information process 10c 1, information process 10c 2, information process 10c 3, and information process 10c 4. Alternatively still, information process 10 may be implemented as a hybrid server-side/client-side process via information process lOs in combination with one or more of information process 10c 1, information process 10c 2, information process 10c 3, and information process 10c 4. Accordingly, information process 10 as used in this disclosure may include any combination of information process 10s , information process 10c 1, information process 10c 2, information process 10c 3, and information process 10c 4.

Information process lOs may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, or a cloud-based computing platform.

The instruction sets and subroutines of information process 10s , which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random-access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of information processes 10c 1, 10c 2, 10c 3, 10c 4 may include but are not limited to a smart television user interface, a SmartTV box user interface, a web browser, a game console user interface, a mobile device user interface, or a specialized application (e.g., an application running on e.g., the Android™ platform, the iOS™ platform, the Windows™ platform, the Linux™ platform or the UNIX™ platform). The instruction sets and subroutines of information processes 10c 1, 10c 2, 10c 3, 10c 4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to, a smartphone (not shown), a personal digital assistant (not shown), a smart television (not shown), a SmartTV box (not shown), laptop computer 28, tablet computer 30, virtual assistant 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access information process 10 directly through network 14 or through secondary network 18. Further, information process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and tablet computer 30 are shown wirelessly coupled to network 14 via wireless communication channels 44, 46 (respectively) established between laptop computer 28, tablet computer 30 (respectively) and cellular network/bridge 48, which is shown directly coupled to network 14. Further, virtual assistant 32 is shown wirelessly coupled to network 14 via wireless communication channel 50 established between virtual assistant 32 and wireless access point (i.e., WAP 52), which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between laptop computer 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

Information Process Overview

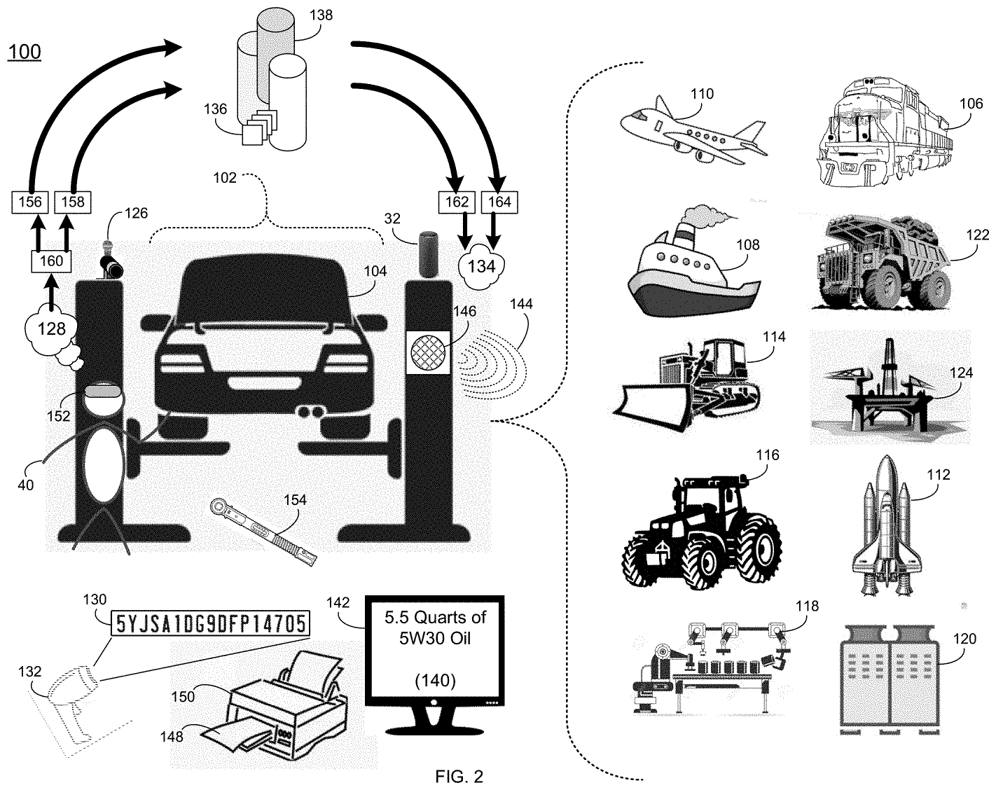

Referring also to FIG. 2 and as will be discussed below in greater detail, information process 10 may be configured to enable a deskless worker (e.g., user 40) to easily obtain information for the various projects that they are working on in a work environment (e.g., work environment 100).

While a desk worker may have access to a desktop computer and various information resources at their fingertips, deskless workers (e.g., user 40) are often at a disadvantage. For example, the access that a deskless worker has to computer systems may be limited. Further, keyboard-based inquiries when trying to obtain information may be inconvenient due to the environment (e.g., work environment 100) in which the deskless worker is operating (e.g., dirty conditions, weather conditions, hazardous conditions).

Textless-Input for a Mechanical Asset

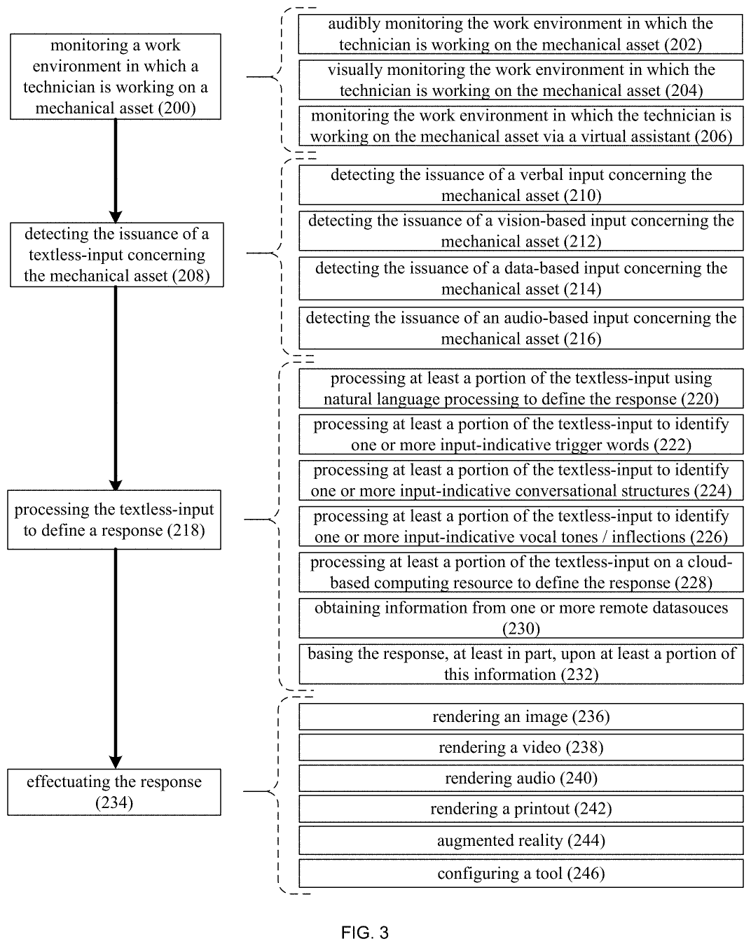

Referring also to FIG. 3, information process 10 may monitor 200 a work environment (e.g., work environment 100) in which a technician (e.g., user 40) is working on a mechanical asset (e.g., mechanical asset 102).

Examples of the mechanical asset (e.g., mechanical asset 102) may include but are not limited to: a transportation mechanical asset such as a vehicle (e.g., wheeled vehicle 104; railed vehicle 106; watercraft 108; aircraft 110; and spacecraft 112); a heavy equipment mechanical asset (e.g., bulldozer 114); an agricultural mechanical asset (e.g., tractor 116); a manufacturing mechanical asset (e.g., assembly line robot 118); a building mechanical asset (e.g., cooling tower 120); a mining mechanical asset (e.g., rock truck 122); and a drilling mechanical (e.g., drilling rig 124).

In a situation in which the mechanical asset (e.g., mechanical asset 102) is a wheeled vehicle (e.g., wheeled vehicle 104), such as a car, an SUV, a van, a truck, a bus, a tractor-trailer), an example of the work environment (e.g., work environment 100) may include but is not limited to a vehicle service bay.

When monitoring 200 a work environment (e.g., work environment 100) in which a technician (e.g., user 40) is working on a mechanical asset (e.g., mechanical asset 102), information process 10 may: audibly monitor 202 the work environment (e.g., work environment 100) in which the technician (e.g., user 40) is working on the mechanical asset (e.g., mechanical asset 102) and/or visually monitor 204 the work environment (e.g., work environment 100) in which the technician (e.g., user 40) is working on the mechanical asset (e.g., mechanical asset 102). For example, an AV device (e.g., audio/video device 126) that includes a camera assembly and a microphone assembly may be positioned proximate the work environment (e.g., work environment 100) in which the technician (e.g., user 40) is working on the mechanical asset (e.g., mechanical asset 102), thus enabling the audible monitoring 202 and visual monitoring 204 of the work environment (e.g., work environment 100) by information process 10. Additionally/alternatively and when utilizing a portable computing device (e.g., laptop computer 28/tablet computer 30), the audible monitoring 202 and/or visual monitoring 204 of the work environment (e.g., work environment 100) by information process 10 may occur via a camera (not shown) and microphone (not shown) included within these devices. Additionally/alternatively, the audible monitoring 202 and/or visual monitoring 204 of the work environment (e.g., work environment 100) by information process 10 may occur via a microphone/camera assembly that is worn by a technician (e.g., user 40) working on the mechanical asset (e.g., mechanical asset 102). For example, the technician (e.g., user 40) may wear a lapel microphone or an AV headset to enable the audible monitoring 202 and/or visual monitoring 204 of the work environment (e.g., work environment 100) by information process 10.

Additionally/alternatively, information process 10 may monitor 206 the work environment (e.g., work environment 100) in which the technician (e.g., user 40) is working on the mechanical asset (e.g., mechanical asset 102) via a virtual assistant (e.g., virtual assistant 32). For example, a microphone (not shown) within virtual assistant 32 may be configured to audibly monitor 202 the work environment (e.g., work environment 100) in which the technician (e.g., user 40) is working on the mechanical asset (e.g., mechanical asset 102). Additionally, a camera (not shown) within virtual assistant 32 may be configured to visually monitor 204 the work environment (e.g., work environment 100) in which the technician (e.g., user 40) is working on the mechanical asset (e.g., mechanical asset 102).

As is known in the art, a virtual assistant is a software agent that can perform tasks or services for an individual based on commands or questions. The term “chatbot” is sometimes used to refer to virtual assistants generally or specifically accessed by online chat. In some cases, online chat programs are exclusively for entertainment purposes. Some virtual assistants are able to interpret human speech and respond via synthesized voices. Users can ask their assistants questions, control home automation devices and media playback via voice, and manage other basic tasks such as email, to-do lists, and calendars with speech-based commands. A similar concept, however with differences, lays under the dialogue systems. As of 2017, the capabilities and usage of virtual assistants are expanding rapidly, with new products entering the market and a strong emphasis on both email and voice user interfaces. Apple and Google have large installed bases of users on smartphones. Microsoft has a large installed base of Windows-based personal computers, smartphones and smart speakers. Amazon has a large install base for smart speakers. Conversica has over 100 million engagements via its email and SMS interface intelligent virtual assistants for business.

Information process 10 may detect 208 the issuance of a textless-input (e.g., textless-input 128) concerning the mechanical asset (e.g., mechanical asset 102) being worked on by the technician (e.g., user 40) within the work environment (e.g., work environment 100). Examples of the textless-input (e.g., textless-input 128) may include but are not limited to one or more of: a verbal input (e.g., a verbal inquiry issued by the technician (e.g., user 40)), a vision-based input (e.g., a visual command issued by the technician (e.g., user 40)), a data-based input (e.g., visually scanned data obtained within work environment 100), and an audio-based input (e.g., an audio-based command generated by the technician (e.g., user 40)).

Accordingly and when detecting 208 the issuance of a textless-input (e.g., textless-input 128) concerning the mechanical asset (e.g., mechanical asset 102), information process 10 may: detect 210 the issuance of a verbal input (e.g., textless-input 128) concerning the mechanical asset (e.g., mechanical asset 102); detect 212 the issuance of a vision-based input (e.g., textless-input 128) concerning the mechanical asset (e.g., mechanical asset 102); detect 214 the issuance of a data-based input (e.g., textless-input 128) concerning the mechanical asset (e.g., mechanical asset 102); and detect 216 the issuance of an audio-based input (e.g., textless-input 128) concerning the mechanical asset (e.g., mechanical asset 102).
Verbal Input: For example and when detecting 208 the issuance of a textless-input (e.g., textless-input 128) concerning the mechanical asset (e.g., mechanical asset 102), information process 10 may detect 210 the issuance of a verbal input concerning the mechanical asset (e.g., mechanical asset 102), such as the technician (e.g., user 40) who is working on the mechanical asset (e.g., mechanical asset 102) saying “Hey Rain . . . what is the oil capacity of a 1997 Honda Accord?”
Vision-Based Input: For example and when detecting 208 the issuance of a textless-input (e.g., textless-input 128) concerning the mechanical asset (e.g., mechanical asset 102), information process 10 may detect 212 the issuance of a vision-based input concerning the mechanical asset (e.g., mechanical asset 102), such as the technician (e.g., user 40) who is working on the mechanical asset (e.g., mechanical asset 102) moving their arm in a unique fashion or executing some other form of gesture that is recognizable by information process 10.
Data-Based Input: For example and when detecting 208 the issuance of a textless-input (e.g., textless-input 128) concerning the mechanical asset (e.g., mechanical asset 102), information process 10 may detect 214 the issuance of a data-based input concerning the mechanical asset (e.g., mechanical asset 102), such as the technician (e.g., user 40) who is working on the mechanical asset (e.g., mechanical asset 102) scanning a VIN code (e.g., VIN code 130) with a scanner (e.g., scanner 132), which may be handheld or permanently affixed within the work environment (e.g., work environment 100).
Audio-Based Input: For example and when detecting 208 the issuance of a textless-input (e.g., textless-input 128) concerning the mechanical asset (e.g., mechanical asset 102), information process 10 may detect 216 the issuance of an audio-based input concerning the mechanical asset (e.g., mechanical asset 102), such as the technician (e.g., user 40) who is working on the mechanical asset (e.g., mechanical asset 102) e.g., beeping a car horn or ringing a buzzer.

Once received, information process 10 may process 218 the textless-input (e.g., textless-input 128) to define a response (e.g., response 134), wherein this response (e.g., response 134) may be provided to the technician (e.g., user 40) who is working on the mechanical asset (e.g., mechanical asset 102).

When processing 218 the textless-input (e.g., textless-input 128) to define a response (e.g., response 134), information process 10 may process 220 at least a portion of the textless-input (e.g., textless-input 128) using natural language processing to define the response (e.g., response 134). As is known in the art, natural language processing is a subfield of linguistics, computer science, and artificial intelligence concerned with the interactions between computers and human language, in particular how to program computers to process and analyze large amounts of natural language data. The goal is a computer capable of “understanding” the contents of documents, including the contextual nuances of the language within them. The technology can then accurately extract information and insights contained in the documents as well as categorize and organize the documents themselves.

When processing 218 the textless-input (e.g., textless-input 128) to define a response (e.g., response 134), information process 10 may:
process 222 at least a portion of the textless-input (e.g., textless-input 128) to identify one or more input-indicative trigger words (e.g., “Hey Rain”, “Hey Ortho”, “OK Ortho”);
process 224 at least a portion of the textless-input (e.g., textless-input 128) to identify one or more input-indicative conversational structures (e.g., “Please get me . . . ”, “Show me . . . ”, “What is . . . ”, “How do I . . . ”); and/or
process 226 at least a portion of the textless-input (e.g., textless-input 128) to identify one or more input-indicative vocal tones/inflections (e.g., questioning tones/inflections, inquisitive tones/inflections, confused tones/inflections).

The above-described input-indicative trigger words, input-indicative conversational structures, and input-indicative vocal tones/inflections may be manually defined or may be automatically defined. For example, an administrator of information process 10 may manually define one or more lists (e.g., lists 54) that identify such input-indicative trigger words, input-indicative conversational structures, and input-indicative vocal tones/inflections. Additionally/alternatively, an administrator of information process 10 may define seed data (e.g., seed data 56) that may be processed via artificial intelligence (AI) process 58 that may be configured to expand seed data 56 to define the above-referenced lists (e.g., lists 54).

As is known in the art, a machine learning system or model may generally include an algorithm or combination of algorithms that has been trained to recognize certain types of patterns. For example, machine learning approaches may be generally divided into three categories, depending on the nature of the signal available: supervised learning, unsupervised learning, and reinforcement learning. As is known in the art, supervised learning may include presenting a computing device with example inputs and their desired outputs, given by a “teacher”, where the goal is to learn a general rule that maps inputs to outputs. With unsupervised learning, no labels are given to the learning algorithm, leaving it on its own to find structure in its input. Unsupervised learning can be a goal in itself (discovering hidden patterns in data) or a means towards an end (feature learning). As is known in the art, reinforcement learning may generally include a computing device interacting in a dynamic environment in which it must perform a certain goal (such as driving a vehicle or playing a game against an opponent). As it navigates its problem space, the program is provided feedback that's analogous to rewards, which it tries to maximize. While three examples of machine learning approaches have been provided, it will be appreciated that other machine learning approaches are possible within the scope of the present disclosure.

In order to harness greater processing power, when processing 218 the textless-input (e.g., textless-input 128) to define a response (e.g., response 134), information process 10 may process 228 at least a portion of the textless-input (e.g., textless-input 128) on a cloud-based computing resource to define the response (e.g., response 134). As is known in the art, cloud computing is the on-demand availability of computer system resources, especially data storage (cloud storage) and computing power, without direct active management by the user. Large clouds often have functions distributed over multiple locations, each location being a data center. Cloud computing relies on sharing of resources to achieve coherence and typically using a “pay-as-you-go” model which can help in reducing capital expenses but may also lead to unexpected operating expenses for unaware users.

When processing 218 the textless-input (e.g., textless-input 128) to define a response (e.g., response 134), information process 10 may: obtain 230 information (e.g., information 136) from one or more remote datasources (e.g., datasources 138); and base 232 the response (e.g., response 134), at least in part, upon at least a portion of this information (e.g., information 136).

Examples of the remote datasources (e.g., datasources 138) may include one or more of: a cloud-based datasource; an internet-based datasource; an intranet-based datasource; a local, preinstalled datasource, an automotive information datasource; a Motor™ datasource; a Chilton™ datasource; and an AllData™ datasource. As is known in the art, Motor™, Chilton™ and AllData™ are information authorities in the motor vehicle space that provide users (e.g., user 40) with technical/repair information concerning vehicles. As is known in the art, a local, preinstalled datasource may be any datasource that is available locally (e.g., stored on a local computing device) and, therefore, does not require online access in order to be accessed.

Information process 10 may effectuate 234 the response (e.g., response 134), wherein effectuating 234 the response (e.g., response 134) may include one or more of: rendering 236 an image; rendering 238 a video; rendering 240 audio; rendering 242 a printout; augmenting 244 reality; and configuring 246 a tool.

Rendering an Image: Information process 10 may effectuate 234 response 134 by rendering 236 an image (e.g., image 140) on monitor 142 that illustrates (in this example) “5.5 Quarts of 5W30 Oil” in response to the technician (e.g., user 40) who is working on the mechanical asset (e.g., mechanical asset 102) saying “Hey Rain . . . what is the oil capacity of a 1997 Honda Accord?” Additionally/alternatively and when utilizing a portable computing device (e.g., laptop computer 28/tablet computer 30), monitor 142 may be included within these devices.

Rendering a Video: Information process 10 may effectuate 234 response 134 by rendering 238 a video (not shown) on monitor 142 that illustrates (in this example) “5.5 Quarts of 5W30 Oil” in response to the technician (e.g., user 40) who is working on the mechanical asset (e.g., mechanical asset 102) saying “Hey Rain . . . what is the oil capacity of a 1997 Honda Accord?” Additionally/alternatively and when utilizing a portable computing device (e.g., laptop computer 28/tablet computer 30), monitor 142 may be included within these devices.

Rendering Audio: Information process 10 may effectuate 234 response 134 by rendering 240 audio (e.g., audio 144) on speaker 146 that says (in this example) “5.5 Quarts of 5W30 Oil” in response to the technician (e.g., user 40) who is working on the mechanical asset (e.g., mechanical asset 102) saying “Hey Rain . . . what is the oil capacity of a 1997 Honda Accord?” Additionally/alternatively and when utilizing a portable computing device (e.g., laptop computer 28/tablet computer 30), speaker 146 may be included within these devices.

Rendering a Printout: Information process 10 may effectuate 234 response 134 by rendering 242 a printout (e.g., printout 148) on printer 150 that illustrates (in this example) “5.5 Quarts of 5W30 Oil” in response to the technician (e.g., user 40) who is working on the mechanical asset (e.g., mechanical asset 102) saying “Hey Rain . . . what is the oil capacity of a 1997 Honda Accord?”

Augmenting Reality: Information process 10 may effectuate 234 response 134 by rendering 244 an image (e.g., not shown) on augmented reality device 152 (e.g., a Google Glass™ headset) that illustrates (in this example) “5.5 Quarts of 5W30 Oil” in response to the technician (e.g., user 40) who is working on the mechanical asset (e.g., mechanical asset 102) saying “Hey Rain . . . what is the oil capacity of a 1997 Honda Accord?”

Configuring a Tool: Information process 10 may effectuate 234 response 134 by configuring 246 a tool (e.g., electrically-configurable torque wrench 154) to 90 ft-lbs in response to the technician (e.g., user 40) who is working on the mechanical asset (e.g., mechanical asset 102) saying “Hey Rain . . . please set my torque wrench for the lug nuts on a 1997 Honda Accord.”

Multi-Datasource Searching

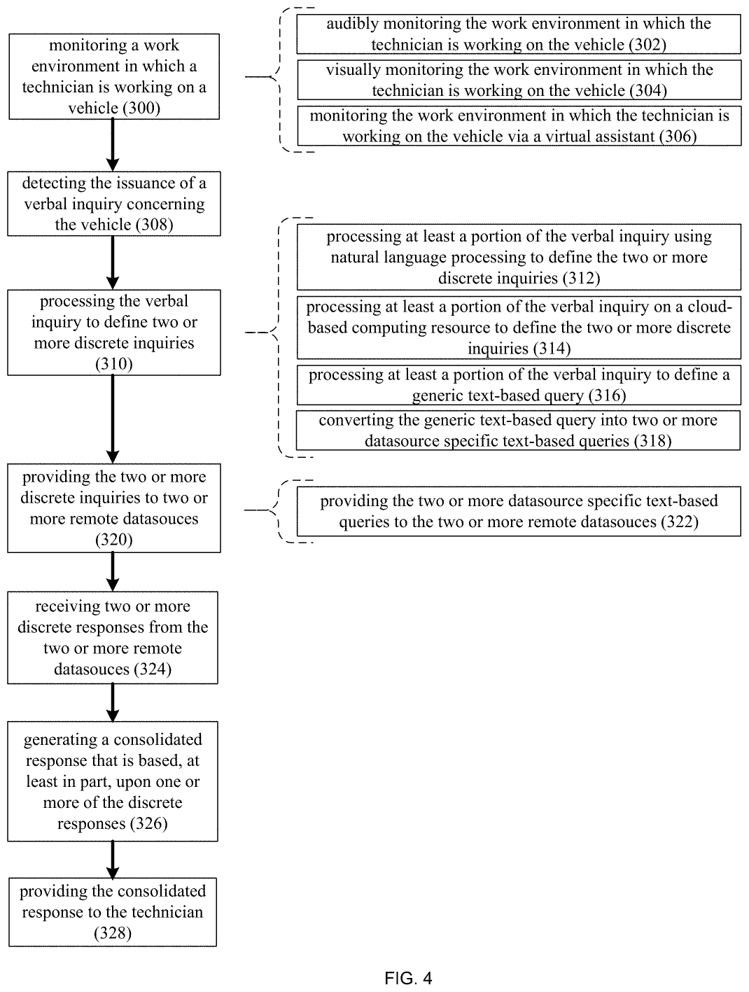

Referring also to FIG. 4, information process 10 may monitor 300 a work environment (e.g., work environment 100) in which a technician (e.g., user 40) is working on a vehicle (e.g., wheeled vehicle 104; railed vehicle 106; watercraft 108; aircraft 110; and spacecraft 112). As discussed above, in a situation in which a wheeled vehicle (e.g., wheeled vehicle 104) is being serviced, such as a car, an SUV, a van, a truck, a bus, a tractor-trailer), an example of the work environment (e.g., work environment 100) may include but is not limited to a vehicle service bay.

As also discussed above and when monitoring 300 a work environment (e.g., work environment 100) in which a technician (e.g., user 40) is working on a vehicle (e.g., wheeled vehicle 104; railed vehicle 106; watercraft 108; aircraft 110; and spacecraft 112), information process 10 may: audibly monitor 302 the work environment (e.g., work environment 100) in which the technician (e.g., user 40) is working on the vehicle (e.g., wheeled vehicle 104; railed vehicle 106; watercraft 108; aircraft 110; and spacecraft 112); and/or visually monitor 304 the work environment (e.g., work environment 100) in which the technician (e.g., user 40) is working on the vehicle (e.g., wheeled vehicle 104; railed vehicle 106; watercraft 108; aircraft 110; and spacecraft 112). For example, an AV device (e.g., audio/video device 126) that includes a camera assembly and a microphone assembly may be positioned proximate the work environment (e.g., work environment 100) in which the technician (e.g., user 40) is working on the vehicle (e.g., wheeled vehicle 104; railed vehicle 106; watercraft 108; aircraft 110; and spacecraft 112), thus enabling the audible monitoring 302 and visual monitoring 304 of the work environment (e.g., work environment 100) by information process 10. Additionally/alternatively and when utilizing a portable computing device (e.g., laptop computer 28/tablet computer 30), the audible monitoring 302 and visual monitoring 304 of the work environment (e.g., work environment 100) by information process 10 may occur via a camera (not shown) and microphone (not shown) included within these devices.

Additionally/alternatively, information process 10 may monitor 306 the work environment (e.g., work environment 100) in which the technician (e.g., user 40) is working on the vehicle (e.g., wheeled vehicle 104; railed vehicle 106; watercraft 108; aircraft 110; and spacecraft 112) via a virtual assistant (e.g., virtual assistant 32). For example, a microphone (not shown) within virtual assistant 32 may be configured to audibly monitor 302 the work environment (e.g., work environment 100) in which the technician (e.g., user 40) is working on the vehicle (e.g., wheeled vehicle 104; railed vehicle 106; watercraft 108; aircraft 110; and spacecraft 112). Additionally, a camera (not shown) within virtual assistant 32 may be configured to visually monitor 304 the work environment (e.g., work environment 100) in which the technician (e.g., user 40) is working on the vehicle (e.g., wheeled vehicle 104; railed vehicle 106; watercraft 108; aircraft 110; and spacecraft 112).

Information process 10 may detect 308 the issuance of a verbal inquiry (e.g., textless-input 128) concerning the vehicle (e.g., wheeled vehicle 104; railed vehicle 106; watercraft 108; aircraft 110; and spacecraft 112). Once received, information process 10 may process 310 the verbal inquiry (e.g., textless-input 128) to define two or more discrete inquiries (e.g., discrete inquiries 156, 158).

When processing 310 the verbal inquiry (e.g., textless-input 128) to define two or more discrete inquiries (e.g., discrete inquiries 156, 158), information process 10 may: process 312 at least a portion of the verbal inquiry (e.g., textless-input 128) using natural language processing to define the two or more discrete inquiries (e.g., discrete inquiries 156, 158). As discussed above and is known in the art, natural language processing is a subfield of linguistics, computer science, and artificial intelligence concerned with the interactions between computers and human language, in particular how to program computers to process and analyze large amounts of natural language data. The goal is a computer capable of “understanding” the contents of documents, including the contextual nuances of the language within them. The technology can then accurately extract information and insights contained in the documents as well as categorize and organize the documents themselves.

In order to harness greater processing power, when processing 310 the verbal inquiry (e.g., textless-input 128) to define two or more discrete inquiries (e.g., discrete inquiries 156, 158), information process 10 may: process 314 at least a portion of the verbal inquiry (e.g., textless-input 128) on a cloud-based computing resource to define the two or more discrete inquiries (e.g., discrete inquiries 156, 158). As discussed above and is known in the art, cloud computing is the on-demand availability of computer system resources, especially data storage (cloud storage) and computing power, without direct active management by the user. Large clouds often have functions distributed over multiple locations, each location being a data center. Cloud computing relies on sharing of resources to achieve coherence and typically using a “pay-as-you-go” model which can help in reducing capital expenses but may also lead to unexpected operating expenses for unaware users.

When processing 310 the verbal inquiry (e.g., textless-input 128) to define two or more discrete inquiries (e.g., discrete inquiries 156, 158), information process 10 may: process 316 at least a portion of the verbal inquiry (e.g., textless-input 128) to define a generic text-based query (e.g., generic text-based query 160); and convert 318 the generic text-based query (e.g., generic text-based query 160) into two or more datasource specific text-based queries (e.g., discrete inquiries 156, 158).

As discussed above, assume that the technician (e.g., user 40) needs to know the oil capacity of the vehicle they are working on. Accordingly, the technician (e.g., user 40) may say “Hey Rain . . . what is the oil capacity of a 1997 Honda Accord?”. Information process 10 may detect 308 the issuance of this verbal inquiry (e.g., textless-input 128) concerning the vehicle and may process 310 this verbal inquiry (e.g., textless-input 128) to define two or more discrete inquiries (e.g., discrete inquiries 156, 158). Assume that datasources (e.g., datasources 138) include a first datasource that requires queries to be formatted in a first query structure and a second datasource that requires queries to be formatted in a second query structure. Accordingly, information process 10 may process 316 at least a portion of the verbal inquiry (e.g., “Hey Rain . . . what is the oil capacity of a 1997 Honda Accord?”) to define a generic text-based query (e.g., generic text-based query 160), wherein such processing 316 may be accomplished via automated speech recognition (ASR) technology and/or speech-to-text (STT) technology. Information process 10 may then convert 318 the generic text-based query (e.g., generic text-based query 160) into two or more datasource specific text-based queries (e.g., discrete inquiries 156, 158). Accordingly, information process 10 may convert 318 the generic text-based query (e.g., generic text-based query 160) into a first datasource specific text-based query (e.g., discrete inquiry 156) having a first query structure for a first datasource within datasources 138 and into a second datasource specific text-based query (e.g., discrete inquiry 158) having a second query structure for a second datasource within datasources 138.

Information process 10 may then provide 320 the two or more discrete inquiries (e.g., discrete inquiries 156, 158) to two or more remote datasources (e.g., datasources 138). Specifically and when providing 320 the two or more discrete inquiries (e.g., discrete inquiries 156, 158) to the two or more remote datasources (e.g., datasources 138), information process 10 may: provide 322 the above-referenced two or more datasource specific text-based queries that were derived from generic text-based query 160 to the two or more remote datasources (e.g., datasources 138).

The two or more remote datasources (e.g., datasources 138) may then process these two or more discrete inquiries (e.g., discrete inquiries 156, 158) to generate two or more discrete responses (e.g., discrete response 162, 164). Information process 10 may receive 324 the two or more discrete responses (e.g., discrete response 162, 164) from the two or more remote datasources (e.g., datasources 138).

Information process 10 may generate 326 a consolidated response (e.g., response 134) that is based, at least in part, upon one or more of the discrete responses (e.g., discrete response 162, 164) and may then provide 328 the consolidated response (e.g., response 134) to the technician (e.g., user 40).

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
monitoring a work environment in which a technician is working on a mechanical asset;
detecting the issuance of a textless-input concerning the mechanical asset;
processing the textless-input to define a response; and
effectuating the response.

2. The computer-implemented method of claim 1 wherein monitoring a work environment in which a technician is working on a mechanical asset includes one or more of:
audibly monitoring the work environment in which the technician is working on the mechanical asset;
visually monitoring the work environment in which the technician is working on the mechanical asset; and
monitoring the work environment in which the technician is working on the mechanical asset via a virtual assistant.

3. The computer-implemented method of claim 1 wherein the mechanical asset includes one or more of:
a transportation mechanical asset;
a heavy equipment mechanical asset;
an agricultural mechanical asset;
a manufacturing mechanical asset;
a building mechanical asset;
a mining mechanical asset; and
a drilling mechanical.

4. The computer-implemented method of claim 1 wherein detecting the issuance of a textless-input concerning the mechanical asset includes one or more of:
detecting the issuance of a verbal input concerning the mechanical asset;
detecting the issuance of a vision-based input concerning the mechanical asset;
detecting the issuance of a data-based input concerning the mechanical asset; and
detecting the issuance of an audio-based input concerning the mechanical asset.

5. The computer-implemented method of claim 1 wherein the textless-input includes one or more of:
a verbal input,
a vision-based input,
a data-based input, and
an audio-based input.

6. The computer-implemented method of claim 1 wherein processing the textless-input to define a response includes:
processing at least a portion of the textless-input using natural language processing to define the response.

7. The computer-implemented method of claim 1 wherein processing the textless-input to define a response includes one or more of:
processing at least a portion of the textless-input to identify one or more input-indicative trigger words;
processing at least a portion of the textless-input to identify one or more input-indicative conversational structures; and
processing at least a portion of the textless-input to identify one or more input-indicative vocal tones/inflections.

8. The computer-implemented method of claim 1 wherein processing the textless-input to define a response includes:
processing at least a portion of the textless-input on a cloud-based computing resource to define the response.

9. The computer-implemented method of claim 1 wherein processing the textless-input to define a response includes one or more of:
obtaining information from one or more remote datasources; and
basing the response, at least in part, upon at least a portion of this information.

10. The computer-implemented method of claim 1 wherein effectuating the response includes one or more of:
rendering an image;
rendering a video;
rendering audio;
rendering a printout;
augmented reality; and
configuring a tool.

11. A computer program product residing on a computer readable medium having a plurality of instructions stored thereon which, when executed by a processor, cause the processor to perform operations comprising:
monitoring a work environment in which a technician is working on a mechanical asset;
detecting the issuance of a textless-input concerning the mechanical asset;
processing the textless-input to define a response; and
effectuating the response.

12. The computer program product of claim 11 wherein monitoring a work environment in which a technician is working on a mechanical asset includes one or more of:
audibly monitoring the work environment in which the technician is working on the mechanical asset;
visually monitoring the work environment in which the technician is working on the mechanical asset; and
monitoring the work environment in which the technician is working on the mechanical asset via a virtual assistant.

13. The computer program product of claim 11 wherein the mechanical asset includes one or more of:
a transportation mechanical asset;
a heavy equipment mechanical asset;
an agricultural mechanical asset;
a manufacturing mechanical asset;
a building mechanical asset;
a mining mechanical asset; and
a drilling mechanical.

14. The computer program product of claim 11 wherein detecting the issuance of a textless-input concerning the mechanical asset includes one or more of:
detecting the issuance of a verbal input concerning the mechanical asset;
detecting the issuance of a vision-based input concerning the mechanical asset;
detecting the issuance of a data-based input concerning the mechanical asset; and
detecting the issuance of an audio-based input concerning the mechanical asset.

15. The computer program product of claim 11 wherein the textless-input includes one or more of:
a verbal input,
a vision-based input,
a data-based input, and
an audio-based input.

16. The computer program product of claim 11 wherein processing the textless-input to define a response includes:
processing at least a portion of the textless-input using natural language processing to define the response.

17. The computer program product of claim 11 wherein processing the textless-input to define a response includes one or more of:
processing at least a portion of the textless-input to identify one or more input-indicative trigger words;
processing at least a portion of the textless-input to identify one or more input-indicative conversational structures; and
processing at least a portion of the textless-input to identify one or more input-indicative vocal tones/inflections.

18. The computer program product of claim 11 wherein processing the textless-input to define a response includes:
processing at least a portion of the textless-input on a cloud-based computing resource to define the response.

19. The computer program product of claim 1 wherein processing the textless-input to define a response includes one or more of:
obtaining information from one or more remote datasources; and
basing the response, at least in part, upon at least a portion of this information.

20. The computer program product of claim 11 wherein effectuating the response includes one or more of:
rendering an image;
rendering a video;
rendering audio;
rendering a printout;
augmented reality; and
configuring a tool.

21. A computing system including a processor and memory configured to perform operations comprising:
monitoring a work environment in which a technician is working on a mechanical asset;
detecting the issuance of a textless-input concerning the mechanical asset;
processing the textless-input to define a response; and
effectuating the response.

22. The computing system of claim 21 wherein monitoring a work environment in which a technician is working on a mechanical asset includes one or more of:
audibly monitoring the work environment in which the technician is working on the mechanical asset;
visually monitoring the work environment in which the technician is working on the mechanical asset; and
monitoring the work environment in which the technician is working on the mechanical asset via a virtual assistant.

23. The computing system of claim 21 wherein the mechanical asset includes one or more of:
a transportation mechanical asset;
a heavy equipment mechanical asset;
an agricultural mechanical asset;
a manufacturing mechanical asset;
a building mechanical asset;
a mining mechanical asset; and
a drilling mechanical.

24. The computing system of claim 21 wherein detecting the issuance of a textless-input concerning the mechanical asset includes one or more of:
detecting the issuance of a verbal input concerning the mechanical asset;
detecting the issuance of a vision-based input concerning the mechanical asset;
detecting the issuance of a data-based input concerning the mechanical asset; and
detecting the issuance of an audio-based input concerning the mechanical asset.

25. The computing system of claim 21 wherein the textless-input includes one or more of:
a verbal input,
a vision-based input,
a data-based input, and
an audio-based input.

26. The computing system of claim 21 wherein processing the textless-input to define a response includes:
processing at least a portion of the textless-input using natural language processing to define the response.

27. The computing system of claim 21 wherein processing the textless-input to define a response includes one or more of:
processing at least a portion of the textless-input to identify one or more input-indicative trigger words;
processing at least a portion of the textless-input to identify one or more input-indicative conversational structures; and
processing at least a portion of the textless-input to identify one or more input-indicative vocal tones/inflections.

28. The computing system of claim 21 wherein processing the textless-input to define a response includes:
processing at least a portion of the textless-input on a cloud-based computing resource to define the response.

29. The computing system of claim 21 wherein processing the textless-input to define a response includes one or more of:
obtaining information from one or more remote datasources; and
basing the response, at least in part, upon at least a portion of this information.

30. The computing system of claim 21 wherein effectuating the response includes one or more of:
rendering an image;
rendering a video;
rendering audio;
rendering a printout;
augmented reality; and
configuring a tool.
